(19) United States
(12) Patent Application Publication
(10) Pub. No.: US 2017/0251741 A1
(43) Pub. Date: Sep. 7, 2017

(54) WIRELESS HEADPHONE HAT

(71) Applicant: Howard Wang, Hacienda Heights, CA (US)

(72) Inventor: Howard Wang, Hacienda Heights, CA (US)

(21) Appl. No.: 15/058,877

(22) Filed: Mar. 2, 2016

(51) Int. Cl. A42B 1/24; H04R 1/02; H04R 3/00; A42B 1/04

(52) U.S. Cl. CPC A42B 1/245; A42B 1/041; A42B 1/242; H04R 1/028; H04R 3/00; H04R 2201/023; H04R 2420/07

(57) ABSTRACT

A wireless headphone hat has a cranial hollow formed inside a dome portion of a fabric headwear. The dome portion includes an inside dome layer. The inside dome layer is covered by an outside dome layer. The inside dome layer is made of fabric material. The outside dome layer is made of fabric material. A brow pocket is connected to a lower edge of the dome portion. The brow pocket includes an inside pocket layer and an outside pocket layer covering the inside pocket layer. The brow pocket is formed around a circumferential periphery of the inside pocket layer. The inside pocket layer is formed as a tubular shape and made of fabric material.

### FIELD OF THE INVENTION

The present invention is in the field of wearable wireless headphone hats.

### DISCUSSION OF RELATED ART

A variety of Bluetooth devices have been introduced into the marketplace for providing wearable headphones integrated into hats. Evidently, many people enjoy listening to music while wearing a hat. A variety of different devices have been provided for audio earphone hats such as by inventor Makins in U.S. Pat. No. 4,776,044, issued Oct. 11, 1988, entitled Hat With Audio Earphones the disclosure of which is incorporated herein by reference. Makins shows a folding pocket for retaining audio earphones. Inventor Boyden in U.S. Pat. No. 5,953,434 issued Aug. 6, 1996 entitled Headband With Audio Speakers provides for a speaker system adapted for a headband, the disclosure of which is incorporated by reference. Alternatively, a speaker system can be installed on a brim of the hat such as described in U.S. Pat. No. 7,044,615 by inventor Gesten, issued Mar. 16, 2006, entitled Audio Assembly And Connection System For Hats. Unfortunately, many of these wireless headphone hats are either not very comfortable, or difficult to maintain and use on a regular basis. Accordingly, an improved wireless headphone hat is desired.

### SUMMARY OF THE INVENTION

A wireless headphone hat has a cranial hollow formed inside a dome portion of a fabric headwear. The dome portion includes an inside dome layer. The inside dome layer is covered by an outside dome layer. The inside dome layer is made of fabric material. The outside dome layer is made of fabric material. A brow pocket is connected to a lower edge of the dome portion. The brow pocket includes an inside pocket layer and an outside pocket layer covering the inside pocket layer. The brow pocket is formed around a circumferential periphery of the inside pocket layer. The inside pocket layer is formed as a tubular shape and made of fabric material.

A pair of hook and loop tape strips includes a first hook and loop tape strip and a second hook and loop tape strip. The pair of hook and loop tape strips are mounted to an outside surface of the inside pocket layer. A first speaker mounted to the first hook and loop tape strip. A second speaker mounted to the second hook and loop tape strip. A speaker wire is electrically connecting the first speaker to the second speaker. A wireless receiver is formed on the second speaker. A control button set is formed on the second speaker. A control panel is attached to the outside pocket layer, wherein the control panel overlies the control button set.

Preferably, the inside dome layer is a fleece material and wherein the outside dome layer is a knitted material. The brow pocket is accessible via a zipper mounted on a zipper opening, wherein the zipper opening is located along a portion of the upper pocket hem stitch formed between the inside dome layer and the inside pocket layer. The control panel includes a control panel window that is light permeable. The wireless headphone hat is a knitted beanie. The control panel includes a control button indicia. The control button indicia is embossed to provide a tactile indication. Preferably, the control panel is raised away from the outer pocket layer and has a raised edge.

Preferably, the dome portion of the hat has a different elasticity than a brow pocket portion of the hat and preferably the dome portion of the hat has a lower elasticity than the brow pocket portion of the hat. The brow pocket portion of the hat is preferably entirely made of knitted material while the dome portion of the hat preferably has a fleece internal liner covered by an outside knitted material which is continuous from the brow pocket portion of the hat to the dome portion of the hat.

It is an object of the invention to provide a combination features to provide a more usable and comfortable hat.

### BRIEF DESCRIPTION OF THE DRAWINGS

FIG. 1 is a perspective exploded view of the present invention.

FIG. 2 is a front view cross-section of the present invention.

FIG. 3 is a top view cross-section of the present invention.

FIG. 4 is a side view cross-section of the present invention with the outside pocket layer removed for clarity.

FIG. 5 is a side exterior view showing the outside portion of the present invention.

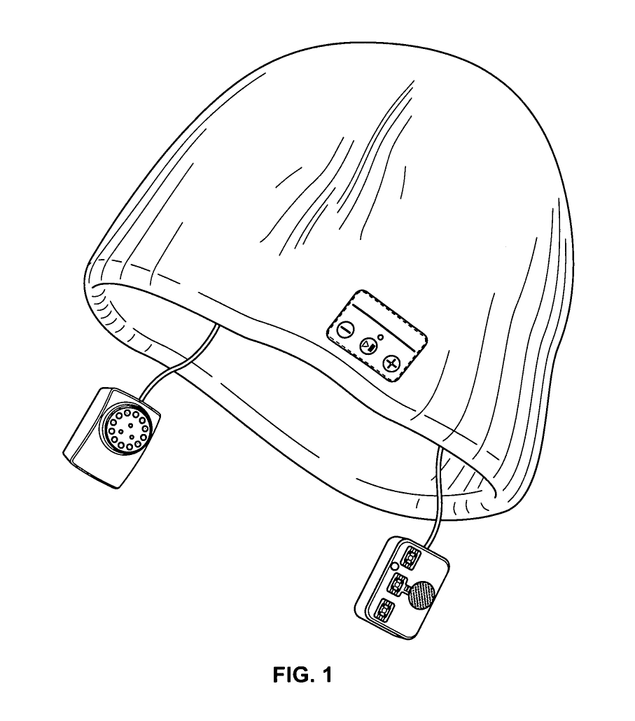

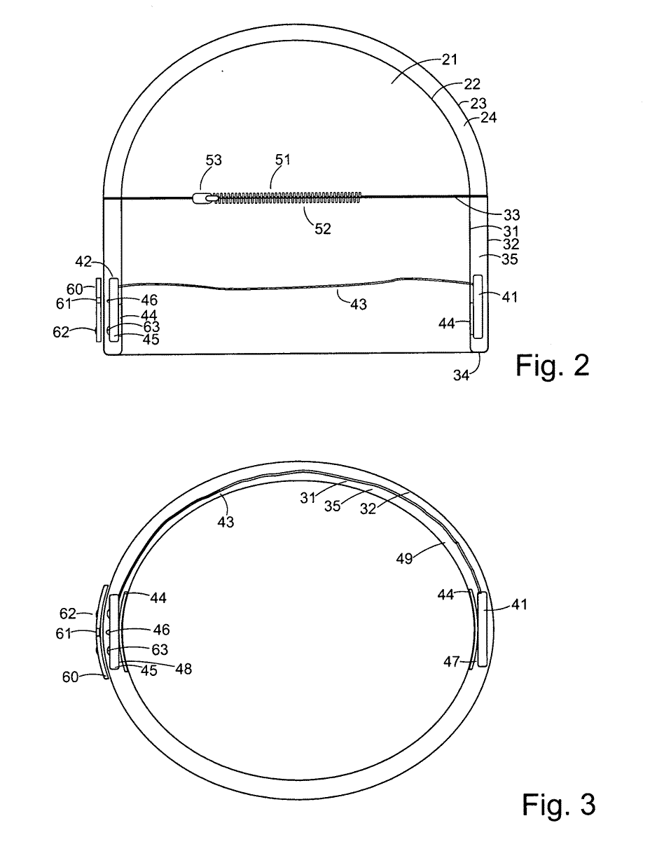

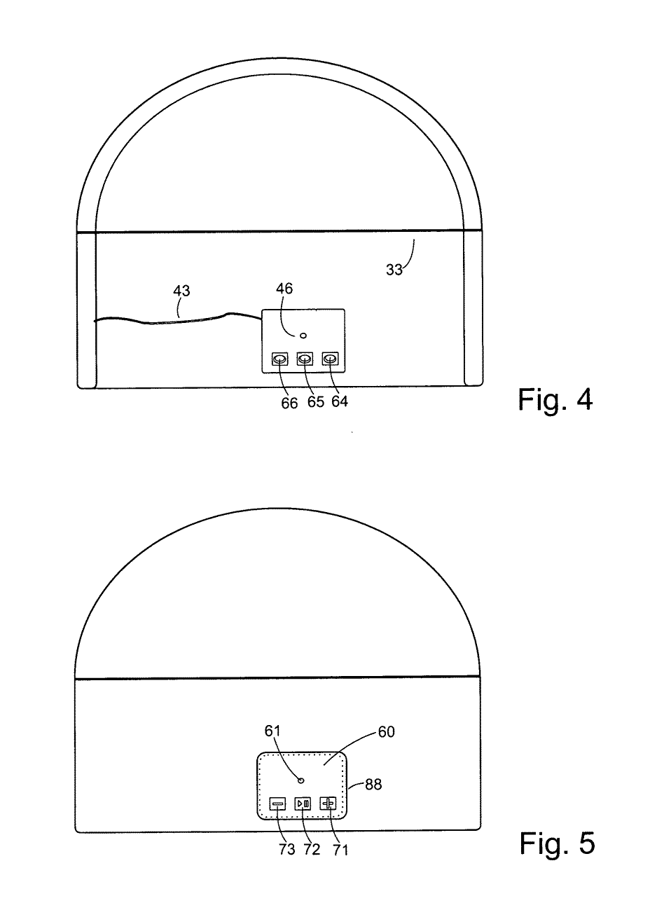

The following callouts can be a useful guide and referencing the element numbers of the drawings.

21 Cranial Hollow

22 Inside Dome Layer

23 Outside Dome Layer

24 Dome Intermediate Portion

31 Inside Pocket Layer

32 Outside Pocket Layer

33 Upper Pocket Stitch

34 Lower Pocket Stitch

35 Brow Pocket

41 First Speaker

42 Second Speaker

43 Speaker Wire Harness

44 Hook And Loop Tape Strip

45 Wireless Receiver

46 LED Indicator

47 First Speaker Inside Surface

48 Second Speaker Inside Surface

49 Inside Pocket Layer Outside Surface

51 Zipper Opening

52 Zipper

53 Zipper Pull

60 Control Panel

61 Control Panel Window

62 Control Button Embossment

63 Control Button Set

64 First Button

65 Second Button

66 Third Button

71 First Graphic Indicator

72 Second Graphic Indicator

73 Third Graphic Indicator

88 Raised Edge

### DETAILED DESCRIPTION OF THE PREFERRED EMBODIMENT

A head covering such as a hat such as a beanie, cap, fedora or sombrero can be outfitted with speakers for Bluetooth functionality. A cranial hollow 21 defines a knitted beanie formed as a cap or hat for wearing by a user. The cranial hollow 21 is formed inside a pair of knitted layers. A first inside dome layer 22 made of a soft fabric such as fleece is covered by an outside dome layer 23 also made of woven fabric. Woven fabric can be machine woven, or knitted. Accordingly, the woven fabric is sound permeable and can have apertures of 2 mm in diameter if woven from coarse yarn. Preferably, apertures in the knitted fabric are at least as large as 0.1 mm. The fleece fabric has a thickness that does not attenuate the sound emitted from the headphone speakers. The knitted beanie can have a variety of ornamental or functional features such as sunglasses, a solar panel or a visor attached to the knitted beanie.

The cranial hollow 21 has a dome intermediate portion 24 formed between the inside dome layer 22 and the outside dome layer 23. The dome intermediate portion can be a hollow space, or can be filled with an intermediate layer such as a nonwoven polyester fibers or insulation. The dome portion includes the cranial hollow 21 with the inside dome layer 22 and an outside dome layer 23. A lower edge of the dome portion can be connected to a brow pocket portion 35 at an upper pocket stitch 33, or the dome portion can be integrally formed with the brow pocket portion 35. The brow pocket 35 can have an inside pocket layer 31, an outside pocket layer 32 and a brow pocket 35 between the inside pocket layer 31 and the outside pocket layer 32. The brow pocket 35 can optionally connect to the dome intermediate portion 24 so that air passes freely between them. The first speaker 41 has a first speaker inside surface 47 that is connected to the inside pocket layer 31 at a hook and loop tape strip 44. Similarly, the second speaker 42 can have a second speaker inside surface 48 that is connected to the inside pocket layer 31 at a hook and loop tape strip. The pair of hook and loop tape strips are mounted on an the inside pocket layer outside surface 49, by stitching or adhesive. The inside pocket layer 31 and the outside pocket layer 32 are stitched at a lower edge at a lower pocket hem stitch 34.

A user can install the first speaker 41 and the second speaker 42 by accessing the brow pocket 35 via a zipper opening 51. A zipper 52 is mounted to the zipper opening 51 so that a zipper pull 53 can control the opening and closing of the zipper opening 51. The zipper 52 can be made of plastic. The first speaker 41 is connected to the second speaker 42 by a speaker wire harness 43. The speaker wire harness 43 sends a sound signal from the second speaker to the first speaker. The speaker wire harness 43 passes along a length of the brow pocket 35. The brow pocket 35 is preferably of a toroid shape or a tubular shape as shown in the drawings. The brow pocket 35 can have a liner to provide water resistance to the electronic components, namely the first speaker 41, the second speaker 42 and the speaker wire harness 43 connecting the first speaker to the second speaker. The second speaker or the first speaker can have a wireless receiver 45 embedded within. The wireless receiver 45 can be a Bluetooth, Wi-Fi or other type of wireless receiver. When installed, the brow pocket 35 conceals the pair of headphone speakers and provides the look of a regular beanie with music and sound capable of permeating a porous knitted fabric surface of the inside pocket layer 31. The beanie can be used as a liner and covered by a rigid helmet such as a construction hardhat helmet for example.

The user controls the wireless receiver 45 by a control panel 60 formed on an exterior surface of the outside pocket layer 32. The control panel 60 preferably has a control panel window 61 that is at least partially transparent or translucent for allowing a user to see light emitted through the control panel 60. The control panel window 61 allows a user to see the status of an LED indicator 46. The LED indicator 46 preferably emits light of sufficient intensity that can pass through openings on the outside pocket layer 32. The control panel 60 can be stitched to the outside pocket layer 32. The control panel 60 also includes control indicia such as control button embossments 62. The control indicia line up with the control button set 63 within the brow pocket 35. The user can press the control button set 63 by depressing the control indicia on the control panel 60. Since the control panel 60 is relatively flexible and substantially flexible, the user can depress the control button set 63 while the control button set 63 is underneath the outside pocket layer 32 and the control panel 60. The outside pocket layer 32 is optionally cut to provide an opening for mounting the control panel 60, or alternatively the control panel 60 is mounted over the outside pocket layer 32.

The second speaker 42 and the first speaker 41 can be formed with a generally rectangular prism shaped flat plastic injection molded housings. The speaker housings can also house one or more wireless receivers 45. The LED indicator 46 is mounted to the speaker housing opposite a speaker. The control panel 60 conforms to the shape of the outside pocket layer 32 and can be slightly curved as seen from a top view cross-section. Similarly, the hook and loop tape strips 44 also follow the profile of the inside pocket layer 31 and can be curved as seen from a top view cross-section. The hook and loop tape strips 44 are longer than the speaker housings to allow for adjustable positioning. The set of speakers can be removed for washing the fabric portion in a washing machine, but handwashing or dry-cleaning is suggested.

A speaker housing has a first button 64 located next to a second button 65 which is in turn located next to a third button 66. The three buttons, which comprise the control button set 63, are located on a lower portion of the housing. The three buttons are aligned in a row and can have various functions such as next, pause play, and previous. Preferably, the first button 64 corresponds to next, with the second button 65 corresponding to pause play and the third button 66 corresponding to previous. The next and previous buttons can be used for adjusting volume as well such as by changing volume when the button is held down, and providing the next and previous functionality if the button receives a short momentary tap.

The control panel 60 can similarly have a first graphic indicator 71 corresponding to the position of the first button 64. Similarly, the second graphic indicator 72 can correspond to the position of the second button 65. Analogously, the third graphic indicator 73 can correspond to the third button 66. The graphic indicators are preferably embossed as control button embossments 62. The control panel window 61 is preferably circular to provide a circular window for viewing a circular LED indicator 46. The control panel 60 preferably has a thickness that is relatively thin compared to the fabric layers so that the control panel 60 is responsive to a user depressing a button. The control panel 60 has a consistency of a membrane switch that receives a momentary concave deformation for transferring force to a specific button without activating other nearby buttons. Preferably, the control panel is raised away from the outer pocket layer and has a raised edge.

The hook and loop tape strip includes a hook strip that is removable from and laminated to the loop strip. The hook strip can be connected to the speaker and the loop strip can be connected to the outside surface of the inside pocket layer. Alternatively, the loop strip can be connected to the speaker and the hook strip can be connected to the outside surface of the inside pocket layer. The best mode is to stitch the loop strip to the inside pocket layer 31 and provide a small hook strip adhesively connected to the speaker housing. The hook strip connected to the speaker housing is preferably less than half or a third of the length of the loop strip. The hook strip can be formed as a small circular disk for example, but the loop strip should be formed as an elongated rectangular strip.

The pair of speaker housings retaining the first speaker and the second speaker can have a pair of batteries, namely a first battery mounted in the first speaker housing and the second battery mounted in the second speaker housing so that the battery size and weight equalize the weight balance between the pair of speaker housings. The speaker wire harness 43 can be formed as four electrical wires with a pair of wires for the charging of the batteries and a pair of wires for an audio signal.

Due to the wireless Bluetooth configuration, the wireless receiver can receive phone calls as well as music similar to other Bluetooth headsets and headphones. A variety of different wireless protocols can be used for integration and communication between the wireless receiver and a cell phone or MP3 player.

Preferably, the dome portion of the hat has a different elasticity than a brow pocket portion of the hat and preferably the dome portion of the hat has a lower elasticity than the brow pocket portion of the hat. The brow pocket portion of the hat is preferably entirely made of knitted material while the dome portion of the hat preferably has a fleece internal liner covered by an outside knitted material which is externally continuous from the brow pocket portion of the hat to the dome portion of the hat. Since the dome portion of the hat has a lower elasticity, it fits more snugly on the top of the head, while the brow pocket portion of the hat which forms a band around the hat could be less snug.

The foregoing invention can be modified without departing from the scope of the claims as defined below. For example, the beanie could be integrated with a hood of a jacket. Also, for example, the speaker wire 43 can be secured to the brow pocket 35. Also, the outside dome layer 23 can be made of the same material as the outside pocket layer 32 so that the beanie appears to have a uniform outside appearance. Additionally, the tactile feel of the embossed button indicia could include Braille to provide additional tactile confirmation for button pressing while a user is wearing the hat.

1. A wireless headphone hat comprising:
a cranial hollow formed inside a dome portion of a fabric headwear, wherein the dome portion includes an inside dome layer, wherein the inside dome layer is covered by an outside dome layer, wherein the inside dome layer is made of fabric material, wherein the outside dome layer is made of fabric material;
a brow pocket connected to a lower edge of the dome portion, wherein the brow pocket includes an inside pocket layer and an outside pocket layer covering the inside pocket layer, wherein the brow pocket is formed around a circumferential periphery of the inside pocket layer, wherein the inside pocket layer is formed as a tubular shape and made of fabric material;
a pair of hook and loop tape strips, namely a first hook and loop tape strip and a second hook and loop tape strip, wherein the pair of hook and loop tape strips are mounted to an outside surface of the inside pocket layer;
a first speaker mounted to the first hook and loop tape strip;
a second speaker mounted to the second hook and loop tape strip;
a speaker wire is electrically connecting the first speaker to the second speaker;
a wireless receiver formed on the second speaker;
a control button set formed on the second speaker; and
a control panel attached to the outside pocket layer, wherein the control panel overlies the control button set.

2. The wireless headphone hat of claim 1, wherein the inside dome layer is a fleece material and wherein the outside dome layer is a knitted material.

3. The wireless headphone hat of claim 1, wherein the brow pocket is accessible via a zipper mounted on a zipper opening, wherein the zipper opening is located along a portion of the upper pocket hem stitch formed between the inside dome layer and the inside pocket layer.

4. The wireless headphone hat of claim 1, wherein the control panel includes a control panel window that is light permeable.

5. The wireless headphone hat of claim 1, wherein the wireless headphone hat is a knitted beanie.

6. The wireless headphone hat of claim 1, wherein the control panel includes control button indicia.

7. The wireless headphone hat of claim 5, wherein the control button indicia are embossed to provide a tactile indication.

8. The wireless headphone hat of claim 7, wherein the inside dome layer is a fleece material and wherein the outside dome layer is a knitted material.

9. The wireless headphone hat of claim 7, wherein the brow pocket is accessible via a zipper mounted on a zipper opening, wherein the zipper opening is located along a portion of the upper pocket him stitch formed between the inside dome layer and the inside pocket layer.

10. The wireless headphone hat of claim 7, wherein the control panel includes a control panel window that is light permeable.

11. The wireless headphone hat of claim 7, wherein the wireless headphone hat is a knitted beanie.

12. The wireless headphone hat of claim 7, wherein the control panel is raised at her pocket layer and has a raised edge.

13. The wireless headphone hat of claim 12, wherein the inside dome layer is a fleece material and wherein the outside dome layer is a knitted material, wherein the brow pocket is accessible via a zipper mounted on a zipper opening, wherein the zipper opening is located along a portion of the upper pocket him stitch formed between the inside dome layer and the inside pocket layer.

14. The wireless headphone hat of claim 12, wherein the control panel includes a control panel window that is light permeable, wherein the wireless headphone hat is a knitted beanie.

14. The wireless headphone hat of claim 12, wherein the dome portion has a different elasticity than a brow pocket, wherein the dome portion has a lower elasticity than the brow pocket.

15. The wireless headphone hat of claim 14, wherein the brow pocket is made of knitted material while the inside dome layer is made of a fleece liner and is covered by the outside dome layer that is made of knitted material, wherein the knitted material is externally continuous from the brow pocket to the dome portion.
